(19) United States
(12) Patent Application Publication
(10) Pub. No.: US 2022/0402019 A1
(43) Pub. Date: Dec. 22, 2022

(54) MOLDING SAND SUPPLY DEVICE AND MOLDING SAND INSPECTION SYSTEM

(71) Applicant: SINTOKOGIO, LTD., Nagoya-shi (JP)

(72) Inventors: Yuichi OGURA, Nagoya-shi (JP); Shigeyoshi KATO, Nagoya-shi (JP); Yoshimitsu ICHINO, Nagoya-shi (JP)

(73) Assignee: SINTOKOGIO, LTD., Nagoya-shi (JP)

(21) Appl. No.: 17/837,487

(22) Filed: Jun. 10, 2022

(30) Foreign Application Priority Data
Jun. 21, 2021 (JP) 2021-102565

(51) Int. Cl. B22C 5/16; B65G 17/12

(52) U.S. Cl. CPC B22C 5/16; B65G 17/126; B65G 2201/045

(57) ABSTRACT

A molding sand supply device according to one aspect includes a sampling tool to sample molding sand, and a conveying device to convey the molding sand sampled by the sampling tool to a supply position along a bent conveyance path.

### CROSS-REFERENCE TO RELATED APPLICATIONS

This application is based on and claims the benefit of priority from Japanese Patent Application No. 2021-102565 filed on Jun. 21, 2021, the entire contents of which are incorporated herein by reference.

### TECHNICAL FIELD

The present disclosure relates to a molding sand supply device and a molding sand inspection system.

### BACKGROUND

Apparatuses adapted to sample molding sand are used to inspect molding sand, a type of sand used for producing a mold. For example, Patent Literature 1 describes a molding sand sampling device including an arm rotatable about a rotation center, a bucket provided at a distal end of the arm to collect molding sand flowing through a conveyor, and a motor to rotate the arm in a forward direction or a reverse direction.

Patent Literature 2 describes a molding sand inspection system including a bucket to collect molding sand on a conveyor, a bucket drive unit to rotatably support the bucket and drive the bucket, a moving unit to linearly move the bucket drive unit, and an inspection device to receive the collected molding sand from the bucket to inspect properties of the molding sand.

### PRIOR ART DOCUMENT

### Patent Document

Patent Literature 1: Japanese Unexamined Utility Model Publication No. S62-162649
Patent Literature 2: Japanese Unexamined Patent Publication No. 2021-35694

### SUMMARY

As described above, in the apparatuses described in Patent Literatures 1 and 2, the molding sand is conveyed along a conveyance path extending in the circumferential direction around the rotation center or along a linear conveyance path. When the molding sand is conveyed using these apparatuses, an external device to be supplied with the molding sand may have to be installed in a position adjacent to the sampling position of the molding sand to avoid interference between the conveyance path of the molding sand and other equipment. This can limit the flexibility in the layout of the facility including the external device.

Accordingly, an object of the present disclosure is to provide a molding sand supply device and a molding sand inspection system capable of providing an enhanced flexibility in the layout of the facility.

In one aspect, a molding sand supply device comprises a sampling tool to sample molding sand, and a conveying device to convey the molding sand sampled by the sampling tool to a supply position along a bent conveyance path.

In this aspect of the molding sand supply device, since the molding sand is conveyed along a bent conveyance path, it is possible to convey the molding sand to a position away from the sampling position while avoiding interference with existing equipment. As a result, the external device to which the molding sand is supplied can be disposed at a position away from the sampling position, and an enhanced flexibility in the layout of the facility is provided.

In one embodiment, the conveyance path may be a three-dimensionally bent path. In this embodiment, interference with existing equipment can be easily avoided allowing the equipment to be efficiently disposed in the installation space.

In one embodiment of the molding sand supply device, the sampling tool may include a bucket, and the molding sand supply device may further include a bucket drive unit to rotatably support the bucket and drive the bucket, and a moving unit to linearly move the bucket drive unit. In this embodiment, since the bucket itself can be driven while the bucket is linearly moved, the molding sand can be actively collected.

The molding sand supply device according to an embodiment may, further include a conveyance container to receive the molding sand sampled by the sampling tool, with the conveying device to convey the conveyance container containing the molding sand to the supply position along the conveyance path. In this embodiment, since the molding sand is transferred after being received by the conveyance container which is separated from the sampling tool, the molding sand can be conveyed to a position away from the sampling position.

In one embodiment, the conveying device may include a guide member extending along the conveyance path, and a conveyance container drive unit to move the conveyance container from a receiving position to the supply position along t guide member, with the receiving position being where the conveyance container receives the molding sand. In this embodiment, the conveyance container can be reliably conveyed from the receiving position to the supply position.

In one embodiment, the conveyance container drive unit includes a magnet disposed inside the guide member, a carrier to move along the guide member together with the magnet due to an attractive force of the magnet, the conveyance container being fixed to the carrier, and a compressed air supply unit to supply compressed air into the guide member to move the magnet along the guide member. In this embodiment, the molding sand contained in the conveyance container can be reliably conveyed to the supply position by moving the carrier along the guide member with compressed air.

In one embodiment, the conveyance container may include a container body to contain the molding sand, a lid openably and closably provided on an upper portion of the container body, and an elastic body to bias the lid into a closed position with respect to the container body. In this embodiment, since the lid is biased into the closed position with respect to the container body to close the lid, it is possible to prevent the molding sand contained in the container body from spilling out during conveyance, and to suppress a change in the properties of the molding sand.

In one embodiment, the conveyance container may include a container body to contain the molding sand, a lid openably and closably provided on an upper portion of the container body, and a locking mechanism to lock the lid to the container body. Since the molding sand supply device is provided with the locking mechanism, it is possible to prevent the lid from opening unintendedly and the molding sand from leaking out of the conveyance container through an unintendedly opened lid.

In one embodiment, the molding sand supply device may further include a blower to blow gas into the conveyance container. In this embodiment, the molding sand adhering to the conveyance container can be removed by the gas.

In one embodiment, the molding sand supply device may further include a separator to divide the molding sand sampled by the sampling tool into two. In this embodiment, the molding sand sampled by the sampling tool can be divided into two to supply the molding sand to the external device in two separate operations.

A molding sand inspection system according to one aspect includes a sampling tool to sample molding sand, a conveying device to convey the molding sand sampled by the sampling tool to a supply position along a bent conveyance path, and an inspection device to receive the molding sand conveyed to the supply position and inspect properties of the molding sand.

According to this aspect of the molding sand inspection system, since the molding sand is conveyed along the bent conveyance path, it is possible to convey the molding sand to a position which is separated from the sampling position while avoiding interference with existing equipment. As a result, the inspection device to which the molding sand is supplied can be disposed at a position away from the sampling position, and an enhanced flexibility in the layout of the facility can be provided.

According to various aspects and embodiments of the present disclosure, it is possible to enhance the flexibility in the layout of the facility.

### BRIEF DESCRIPTION OF THE DRAWINGS

FIG. 1 is a schematic diagram illustrating a molding sand inspection system including a molding sand supply device according to an embodiment.

FIG. 2 is a cross-sectional view of a guide member and a conveyance container drive unit.

FIG. 3 is a diagram illustrating a procedure for conveying molding sand.

FIG. 4 is a diagram illustrating a procedure for conveying molding sand.

FIG. 5 is a diagram illustrating a procedure for conveying molding sand.

FIG. 6 is a diagram illustrating a procedure for conveying molding sand.

FIG. 7 is a diagram illustrating a procedure for conveying molding sand.

FIG. 8 is a diagram illustrating a procedure for conveying molding sand.

FIG. 9 is a diagram illustrating a procedure for conveying molding sand.

FIG. 10 is a diagram illustrating a procedure for conveying molding sand.

FIG. 11 is a diagram illustrating a procedure for conveying molding sand.

FIG. 12 is a diagram illustrating a procedure for conveying molding sand.

FIG. 13 is a diagram illustrating a procedure for conveying molding sand.

FIG. 14 is a diagram illustrating a modified example of the molding sand supply device.

FIGS. 15A and 15B are diagrams other modified examples of the molding sand supply device.

FIG. 16 are diagrams illustrating another modified example of the molding sand supply device.

### DETAILED DESCRIPTION

Hereinafter, an embodiment of the present disclosure will be described with reference to the drawings. In the following description, the same or corresponding elements are denoted by the same reference numerals, and redundant description will not be repeated. The dimensional ratios in the drawings are not necessarily consistent with those in the description.

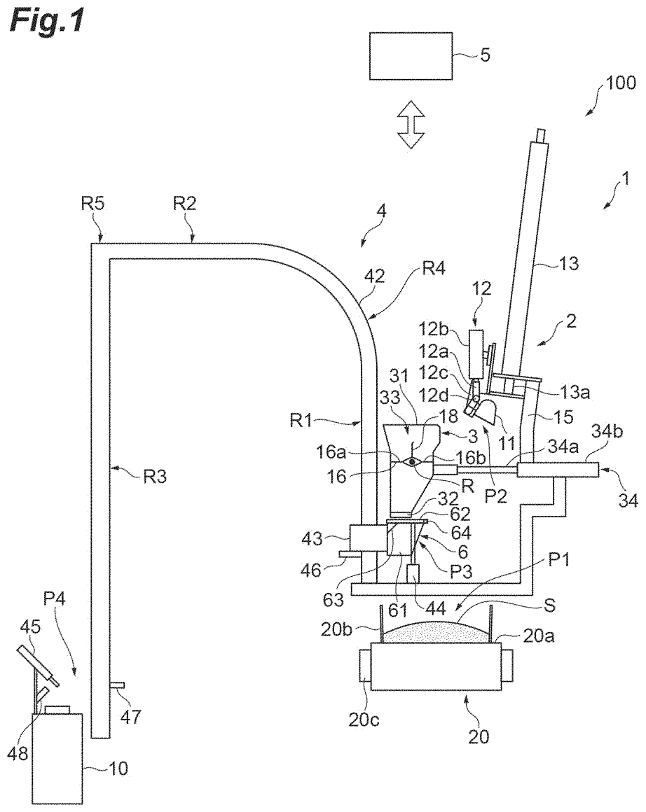

FIG. 1 is a schematic diagram illustrating a molding sand inspection system including a molding sand supply device according to an embodiment. As shown in FIG. 1, a molding sand inspection system 100 is a system for sampling and inspecting molding sand, and includes a molding sand supply device 1 and an inspection device 10.

The molding sand supply device 1 is a device to collect the molding sand S on a conveyance path and convey the collected molding sand S to the supply position P4. The supply position P4 is a position for supplying the molding sand S to the inspection device 10. The molding sand S is used as a raw material of a mold. The molding sand S is, for example, green sand for a green sand mold or core sand for a core.

In the example illustrated in FIG. 1, the molding sand S is disposed on the conveyor 20. The conveyor 20 is, for example, a belt conveyor, and includes a belt 20a forming a conveyance path of the molding sand S, a side wall 20b vertically arranged on the sides of the upper surface of the belt 20a to prevent the molding sand S from falling, and a pulley 20c suspending the belt 20a. The conveyor 20 drives the pulley 20c to rotate the belt 20a, thereby conveying the molding sand S along the extending direction of the conveyor 20. The operation of the pulley 20c is controlled by, for example, a control unit 5 described later. In the following description, a front-rear direction refers to a direction in which the molding sand S is conveyed by the conveyor 20, and a left-right direction refers to a direction perpendicular to the front-rear direction as well as a vertical direction (up-down direction).

As illustrated in FIG. 1, the molding sand supply device 1 according to an embodiment includes a sampling device 2, a conveying device 4, and a control unit 5. The sampling device 2 includes a bucket 11, a bucket drive unit 12, and a moving unit 13 to collect molding sand S on the conveyor 20. The bucket 11 is used as a sampling tool to collect molding sand S. The bucket 11 has an opening and receives the molding sand therein through the opening.

The bucket drive unit 12 rotatably supports the bucket 11 and drives the bucket 11. In the example illustrated in FIG. 1, the bucket drive unit 12 includes a rod 12a movable in the longitudinal direction, and a cylinder main body 12b to drive the rod 12a. The cylinder main body 12b has a fixing member 12c extending to the rod 12a side and fixed to the cylinder main body 12b. The fixing member 12c has a rotation shaft 12d, and the bucket 11 is rotatably attached to the rotation shaft 12d. The bucket drive unit 12 includes, for example, a cylinder that moves the rod 12a forward and backward in the longitudinal direction, and the bucket 11 is attached to the distal end of the rod 12a. When the rod 12a moves forward and backward, the bucket 11 rotates about the rotation shaft 12d as a rotation center. The driving mechanism of the bucket drive unit 12 is not particularly limited, and may be a pneumatic cylinder, a hydraulic cylinder, or an electric cylinder. In addition, the bucket drive unit 12 may include a rotation cylinder (rotary actuator), or may have a drive mechanism including a motor, a chain, a belt, a pulley, and the like.

The bucket drive unit 12 is supported by the moving unit 13. The moving unit 13 moves the bucket drive unit 12 in a direction approaching to and separating from the molding sand S. In the example shown in FIG. 1, the moving unit 13 has a rod 13a movable forward and backward in the longitudinal direction, and the bucket drive unit 12 is coupled to the rod 13a. The moving unit 13 includes a driving mechanism to move the rod 13a forward and backward in the longitudinal direction. Examples of the moving unit 13 includes a pneumatic cylinder, a hydraulic cylinder, or an electric cylinder. The bucket drive unit 12 moves in the direction approaching to and separating from the molding sand S as the rod 13a moves forward and backward by driving of the cylinder. As the bucket drive unit 12 moves, the bucket 11 moves in the direction approaching to and separating from the molding sand S.

The moving unit 13 linearly moves the bucket 11 between a sampling position P1 and a passing position P2. The linear movement means movement along a linear trajectory. Here, the linear movement is movement along a straight line between the sampling position P1 and the passing position P2. The sampling position P1 is a position where the bucket 11 can collect the molding sand S. The passing position P2 is a position where the collected molding sand S can be passed to the transfer container 3 described later. The sampling position P1 and the passing position P2 may be set in advance by the designer. The moving unit 13 is supported above the conveyor 20 by a frame 15.

The molding sand supply device 1 further includes a transfer container 3 and a conveyance container 6, The transfer container 3 transfers the molding sand S collected by the sampling device 2 into the conveyance container 6. As illustrated in FIG. 1, the transfer container 3 has, for example, a tubular shape in which an upper portion has a rectangular cross-sectional shape and a lower portion has a circular cross-sectional shape. The transfer container 3 includes an inlet 31 and an outlet 32. The inlet 31 is formed in an upper portion of the transfer container 3, and the outlet 32 is formed in a lower portion of the inlet 31.

A separator 33 is provided inside the transfer container 3. The separator 33 is disposed between the inlet 31 and the outlet 32, and includes the first plate 16 and the second plate 18. The first plate 16 is interposed between the inlet 31 and the outlet 32, and is disposed substantially horizontally in the transfer container 3. The second plate 18 is provided substantially perpendicular to the first plate, and is disposed to divide the internal space of the transfer container 3 into two in plan view. The upper surface of the first plate 16 is divided into a first region 16a and a second region 16b by the second plate 18. The separator 33 has a rotation shaft R extending along a connection portion between the first plate 16 and the second plate 18, and the separator 33 is rotatable about the rotation shaft R. The rotation shaft R is, for example, a rod member of a rotation cylinder. As the rotation shaft R rotates, the separator 33 rotates about the rotation shaft R.

A transfer container drive unit 34 to move the transfer container 3 in the left-right direction (horizontal direction) is provided on a side relative to the transfer container 3. The transfer container drive unit 34 includes a rod member 34a that moves forward and backward in the left-right direction and a cylinder main body 34b that drives the rod member 34a. The rod member 34a is connected to the transfer container 3. The rod member 34a horizontally moves the transfer container 3 between a position immediately below the passing position P2 and a position immediately above the receiving position P3 as the rod member 34a moves forward and backward. The receiving position P3 is a position at which the conveyance container 6 receives the molding sand S from the transfer container 3. The transfer container drive unit 34 is controlled by the control unit 5 described later.

The conveyance container 6 is a container to which the molding sand S collected by the sampling device 2 is transferred, and includes a container body 61, a lid 62, and an elastic body 63. The container body 61 is a cylindrical container having a bottom portion with an upper portion of the container body 61 being open. The container body 61 defines a space for accommodating the molding sand S therein. The upper opening of the container body 61 can be opened and closed owing to the lid 62. The elastic body 63 is, for example, a spring provided at a hinge portion of the conveyance container 6, and biases the lid 62 into a closed position with respect to the container body 61. Therefore, when no external force applies to the conveyance container 6, the upper opening of the container body 61 is closed by the lid 62 due to the elastic force of the elastic body 63.

In one embodiment, the conveyance container 6 may further include a locking mechanism 64 to lock the lid 62 to the container body 61. By providing the locking mechanism 64, it is possible to prevent molding sand S from leaking out of the conveyance container 6 due to unintended opening of the lid 62. The locking mechanism 64 may include a magnet disposed on one of the container body 61 and the lid 62, and may fix the lid 62 to the container body 61 since the container body 61 and the lid 62 are attracted to each other by the magnetic force of the magnet. When the locking mechanism 64 includes a magnet, the elastic body 63 may bias the lid 62 into the closed position with respect to the container body 61, or may bias the lid 62 into the open position with respect to the container body 61. For example, when the lid 62 is biased by the elastic body 63 in the opening direction with respect to the container body 61, in order to prevent the lid 62 from unintendedly opening, a force of closing the lid 62 by a magnetic force is configured to be greater than a force of opening the lid 62 by the elastic body 63.

The locking mechanism 64 may secure the lid 62 to the container body 61 using a latch mechanism. When the locking mechanism 64 includes the latch mechanism, the elastic body 63 biases the lid 62 into the open position with respect to the container body 61. Since the lid 62 is biased into the open position with respect to the container body 61 by the elastic body 63, the lid 62 is opened by the elastic force of the spring when the lock of the lid 62 is released by the latch mechanism. When the locking mechanism 64 includes a magnet or a latch mechanism, the conveyance container 6 does not need to include the elastic body 63. Also in this case, unintended opening of the lid 62 is prevented by the locking mechanism 64.

The locking mechanism 64 may fix the lid 62 to the container body 61 by a pinch valve. When a pinch valve is used as the locking mechanism 64, the conveyance container 6 does not need to include the elastic body 63.

When the conveyance container 6 is provided with a mechanism for maintaining the conveyance container 6 in a horizontal position, the conveyance container 6 may not include the lid 62. In one embodiment, the conveyance container 6 may be made of ultra-high molecular weight polyethylene or diatomaceous earth. As a result, when the molding sand S is supplied to the inspection device 10, the molding sand is prevented from adhering to the inner wall of the conveyance container 6 and remaining therein. In order to prevent the molding sand from remaining in the conveyance container 6, starch, fine particle powder, or lime powder may be applied to the inner wall of the conveyance container 6. A gel sheet may be provided on the inner surface of the lid 62 such that the molding sand S is prevented from leaking out of the conveyance container 6 and scattering.

The conveying device 4 conveys the molding sand S to the supply position P4 along the bent conveyance path. The bent conveyance path means a path in which the conveying direction changes while the molding sand S is conveyed from the start point to the end point, and includes a linear section and a smoothly curved non-linear section. As illustrated in FIG. 1, the conveying device 4 includes a guide member 42, a conveyance container drive unit 43, a lid opening and closing portions 44 and 45, and stoppers 46 and 47.

The guide member 42 guides the conveyance container 6 so as to be conveyed along the conveying direction. The guide member 42 extends between the receiving position P3 and the supply position P4, and has a shape that bends two-dimensionally between the receiving position P3 and the supply position P4. The two-dimensionally bent shape means that when the conveyance container 6 moves from the receiving position P3 to the supply position P4 along the guide member 42, the movement direction changes in two directions of the left-right direction, the front-rear direction, and the up-down direction. Note that the guide member 42 may have a three-dimensionally bent shape. The three-dimensionally bent shape means that when the conveyance container 6 moves from the receiving position P3 to the supply position P4 along the guide member 42, the movement direction changes in the left-right direction, the front-rear direction, and the up-down direction.

In one embodiment, the guide member 42 includes a linear section extending linearly and a non-linear section extending non-linearly. In the example illustrated in FIG. 1, the guide member 42 includes a linear section R1 extending in the up-down direction, a linear section R2 extending in the left-right direction, and a linear section R3 extending in the up-down direction. Further, a non-linear section R4 having a bent shape is connected between the linear section R1 and the linear section R2, and a non-linear section R5 having a bent shape is connected between the linear section R2 and the linear section R3.

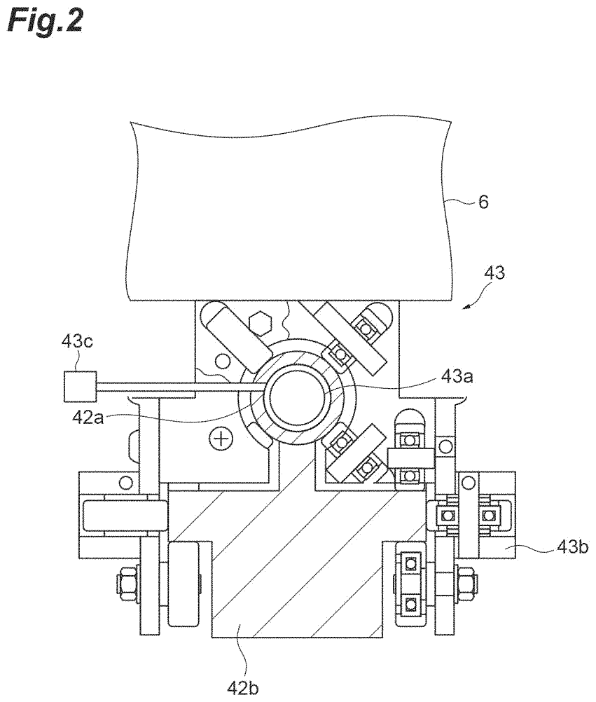

FIG. 2 is a cross-sectional view of an exemplary guide member 42. As shown in FIG. 2, the guide member 42 of one embodiment has a pipe portion 42a having a cylindrical shape and extending along the bent conveyance path and a rail portion 42b extending along the pipe portion 42a.

The conveyance container drive unit 43 moves the conveyance container 6 from the receiving position P3 to the supply position P4 along the guide member 42. In one embodiment, as shown in FIG. 2, the conveyance container drive unit 43 includes a magnet 43a, a carrier 43 and a compressed air supply unit 43c. The magnet 43a has a substantially cylindrical shape, and is disposed inside the pipe portion 42a of the guide member 42. The magnet 43a is movable in the extending direction of the pipe portion 42a inside the pipe portion 42a.

The carrier 43b is disposed so as to surround the pipe portion 42a and the rail portion 42b of the guide member 42. The carrier 43b includes a plurality of rotatable rolling elements (for example, rollers), and is slidable along the guide member 42 by rolling of the plurality of rolling elements. The carrier 43h is provided with a magnet that is attracted to a magnet 43a disposed in the pipe portion 42a. A conveyance container 6 is attached to the carrier 43b.

The compressed air supply unit 43c supplies compressed air into the pipe portion 42a to move the magnet 43a along the extending direction of the guide member 42. When the magnet 43a moves along the guide member 42, the carrier 43b moves along the guide member 42 together with the magnet 43a due to the attractive force of the magnet 43a. Accordingly, the conveyance container 6 moves along the guide member 42 between the receiving position P3 and the supply position P4.

Reference is again made to FIG. 1. The lid opening and closing portions 44 and 45 cause the lid 62 of the conveyance container 6 to open and close. The lid opening and closing portion 44 is arranged close to the receiving position P3. The lid opening and closing portion 44 includes, for example, a rod that moves forward and backward in the longitudinal direction to open or close the lid 62 of the conveyance container 6 disposed at the receiving position P3, The lid opening and closing portion 45 is arranged close to the supply position P4. The lid opening and closing portion 45 includes, for example, a rod that moves forward and backward in the longitudinal direction to open or close the lid 62 of the conveyance container 6 disposed at the supply position P4. For example, the stoppers 46 and 47 are fixed to the guide member 42 to position the conveyance container 6 so that the conveyance container 6 is disposed in the receiving position P3 and the supply position P4.

In one embodiment, the molding sand supply device 1 may further include a blower 48 to output gas toward the conveyance container 6, The blower 48 is, for example, disposed in the vicinity of the supply position P4 and blows gas toward the conveyance container 6 to remove the molding sand S adhered to the inner walls of the conveyance container 6. In order to remove the molding sand S, the molding sand supply device 1 may include, instead of the blower 48, a vibration device that vibrates the conveyance container 6, a suction device that sucks the conveyance container 6, or a brush that cleans the conveyance container 6.

The control unit 5 is a computer including a processor, a storage device, an input device, a display device, a communication device, and the like, and controls the entire operation of the molding sand supply device 1. The control unit 5 loads, for example, a program stored in the storage device and executes the loaded program by a processor to implement various functions described later. In the control unit 5, an operator can input a command and the like to manage the molding sand supply device 1 by using the input device, and an operation status of the molding sand supply device 1 can be visualized and displayed by the display device. The control unit 5 may also have a function of controlling the operation of the inspection device 10.

More specifically, the control unit 5 is communicably connected to the bucket drive unit 12, the moving unit 13, the separator 33, the transfer container drive unit 34, the conveyance container drive unit 43, the lid opening and closing portions 44 and 45, and the valves for actuating the blower 48 (for example, pneumatic valves or hydraulic valves), such that the control unit 5 can control operations of the bucket drive unit 12, the moving unit 13, the rotation shaft R of the separator 33, the transfer container drive unit 34, the conveyance container drive unit 43, the lid opening and closing portions 44 and 45, and the valves for actuating the blower 48.

The inspection device 10 is disposed below the supply position P4, and receives the molding sand S from the conveyance container 6 at the supply position P4 to inspect the molding sand S. The inspection device 10 is, for example, a sand property measuring device, a loss on ignition (LOI) measuring device, or a sand mulling controller. For example, the inspection device 10 measures properties of the molding sand S, such as moisture, a CB value compactability value), compressive strength, transverse strength, air permeability, sand temperature, viscosity, and pH of the molding sand S. The inspection device 10 may inspect the properties of the molding sand S in two separate operations. In this case, the inspection device 10 measures different items relating to properties of the molding sand S in the first inspection and the second inspection.

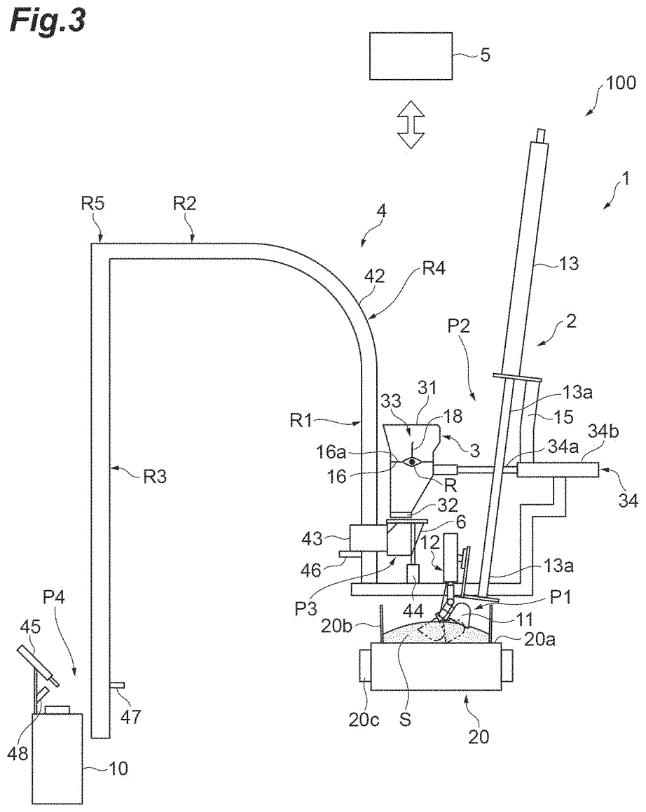

Hereinafter, an example of a procedure to supply the molding sand S to the inspection device 10 by using the molding sand supply device 1 will be described with reference to FIGS. 3 to 13. FIGS. 3 to 13 are schematic diagrams illustrating a procedure of conveying the molding sand S. The molding sand S is conveyed by the control unit 5 controlling the bucket drive unit 12, the moving unit 13, the separator 33, the transfer container drive unit 34, the conveyance container drive unit 43, and the lid opening and closing portions 44 and 45.

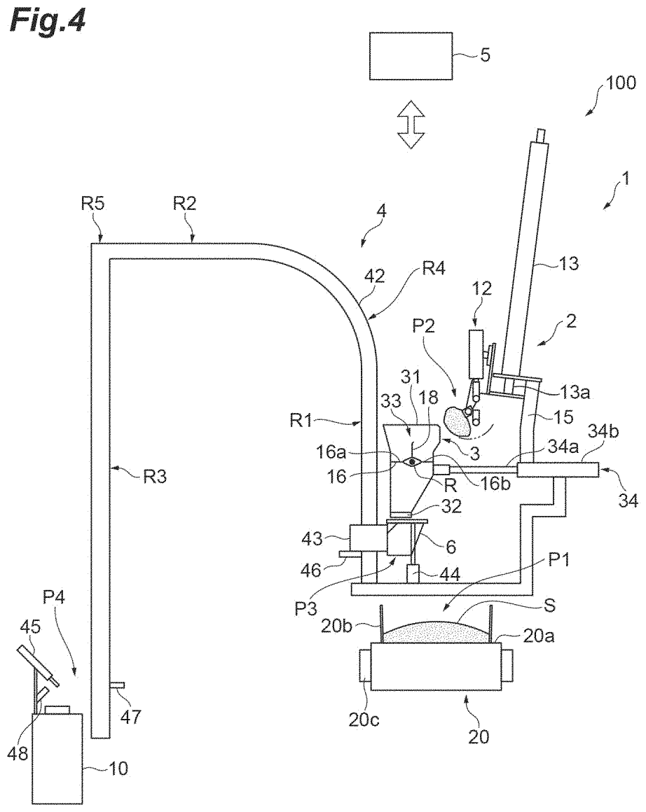

First, as shown in FIG. 3, the control unit 5 drives the moving unit 13 to move the bucket 11 to the sampling position P1. Then, the control unit 5 drives the bucket drive unit 12 to rotate the bucket 11 in a forward direction to collect the molding sand S on the conveyor 20 into the bucket 11, Then, as shown in FIG. 4, the control unit 5 drives the moving unit 13 to move the bucket 11 to the passing position P2.

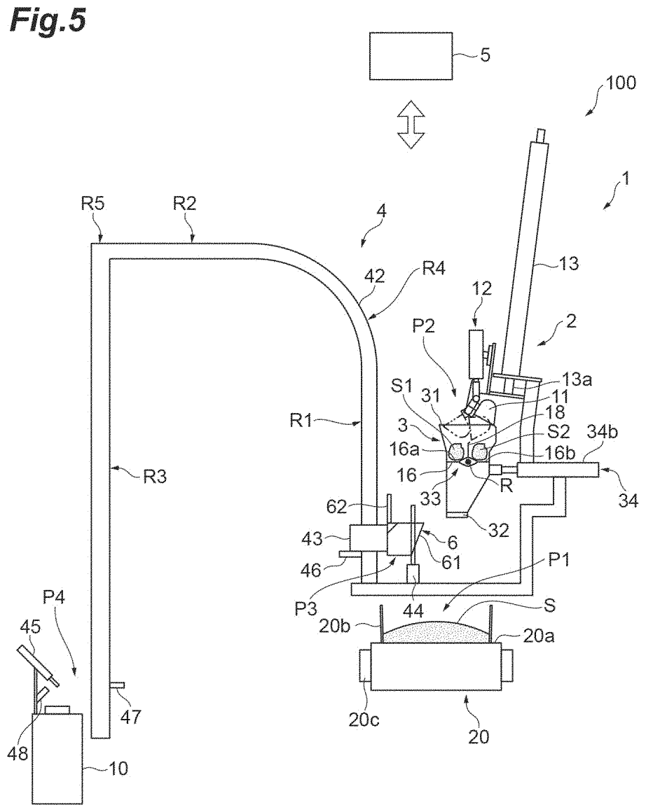

Next, as shown in FIG. 5, the control unit 5 drives the transfer container drive unit 34 to move the transfer container 3 to a position immediately below the passing position P2. Then, the control unit 5 drives the bucket drive unit 12 to rotate the bucket 11 in a reverse direction. As a result, the collected molding sand S falls from the bucket 11 and is supplied to the transfer container 3 via the inlet 31.

The molding sand S supplied from the bucket 11 is received by the separator 33 disposed inside the transfer container 3. At this time, the separator 33 is supported in a posture in which the first plate 16 is in a horizontal position and the second plate 18 is in an upright position. Thus, as shown in FIG. 5, the molding sand S dropped from the bucket 11 is divided into two by the second plate 18. Then, molding sand S 1, which is one part of the molding sand S, is placed on the first region 16a of the first plate 16, and molding sand S2, which is the other part of the molding sand S, is placed on the second region 16b of the first plate 16. Further, the control unit 5 drives the lid opening and closing portion 44 to open the lid 62 of the conveyance container 6 arranged in the receiving position P3.

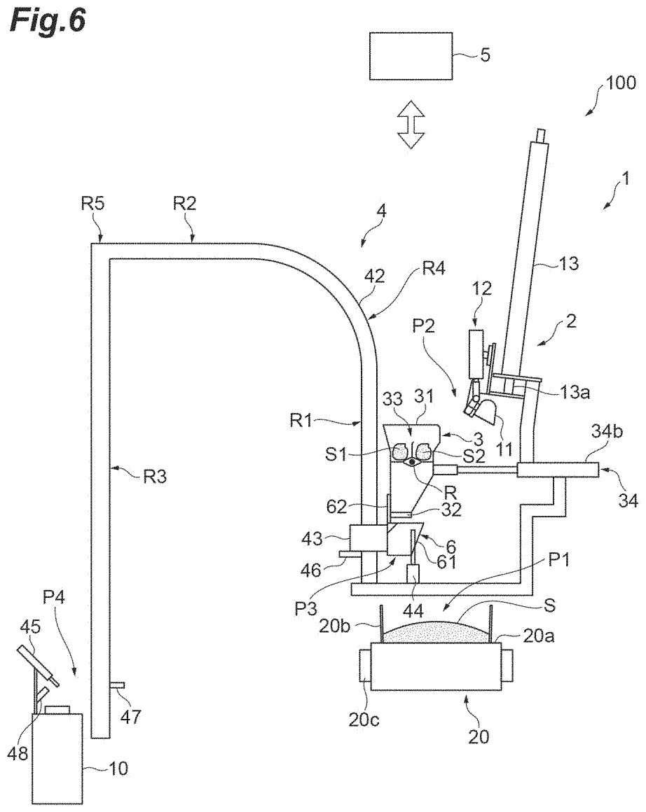

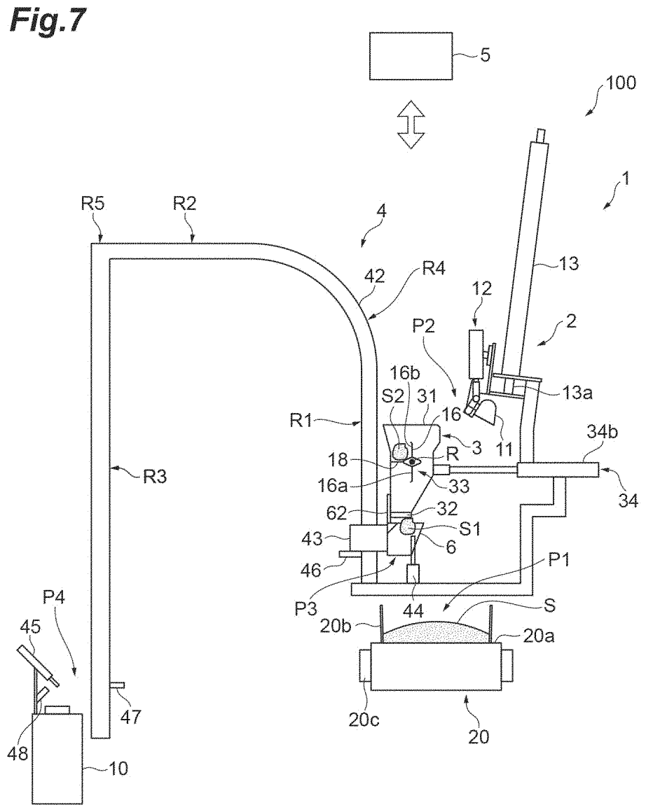

Next, as shown in FIG. 6, the control unit 5 drives the transfer container drive unit 34 to move the transfer container 3 to a position above the receiving position P3. Next, as shown in FIG. 7, the control unit 5 rotates the separator 33 by 90° around the rotation shaft R to drop the molding sand S1 placed on the first region 16a. As a result, the molding sand S1 in the transfer container 3 is transferred to the conveyance container 6. At this time, the molding sand S2 is supported on the second plate 18 of the separator 33 and is kept in the transfer container 3 without being transferred to the conveyance container 6.

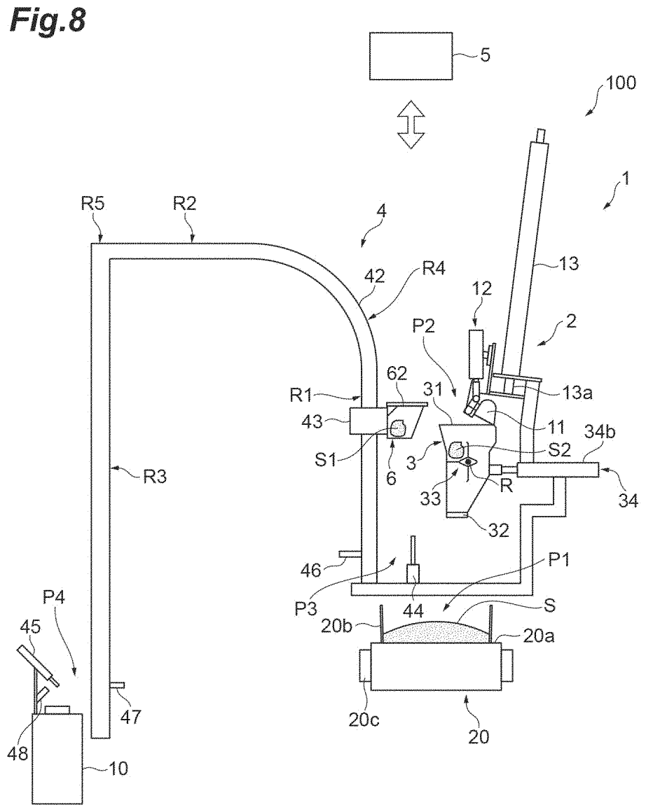

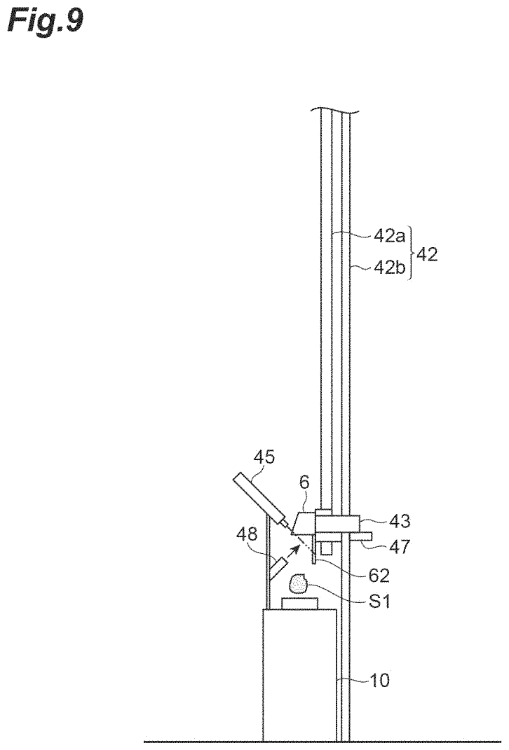

Next, as shown in FIG. 8, the control unit 5 drives the transfer container drive unit 34 to move the transfer container 3 to a position immediately below the passing position P2. Then, the control unit 5 drives the conveyance container drive unit 43 to move the conveyance container 6 from the receiving position P3 to the supply position P4 along the guide member 42. That is, the molding sand S1 contained in the conveyance container 6 is conveyed to the supply position P4 along the bent conveyance path. When the conveyance container 6 reaches the supply position P4, the control unit 5 drives the lid opening and closing portion 45 to open the lid 62 of the conveyance container 6, as shown in FIG. 9. As a result, the molding sand S1 contained in the conveyance container 6 falls from the conveyance container 6 and is supplied to the inspection device 10. At this time, the control unit 5 may have the blower 48 blow gas toward the conveyance container 6 to remove the molding sand adhered to the inner wall of the conveyance container 6. The inspection device 10 inspects the properties of the molding sand S1 supplied from the conveyance container 6.

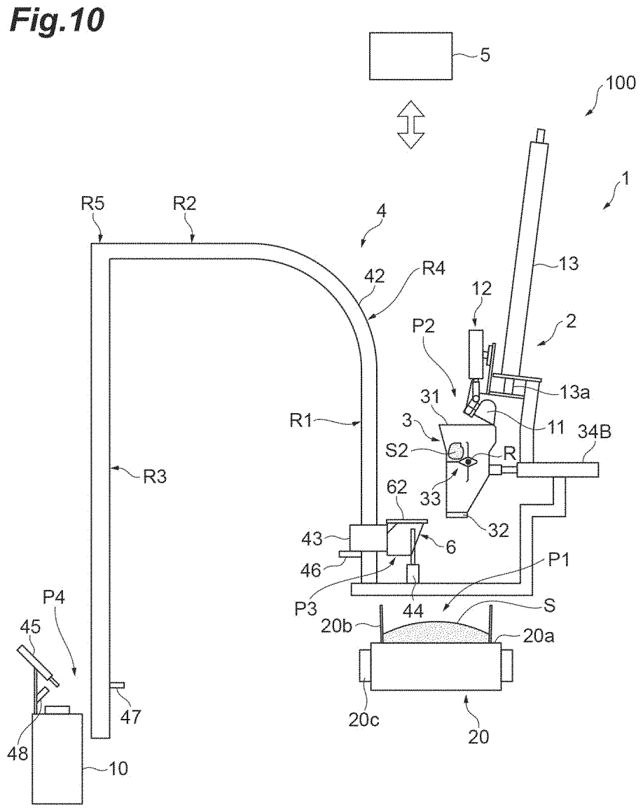

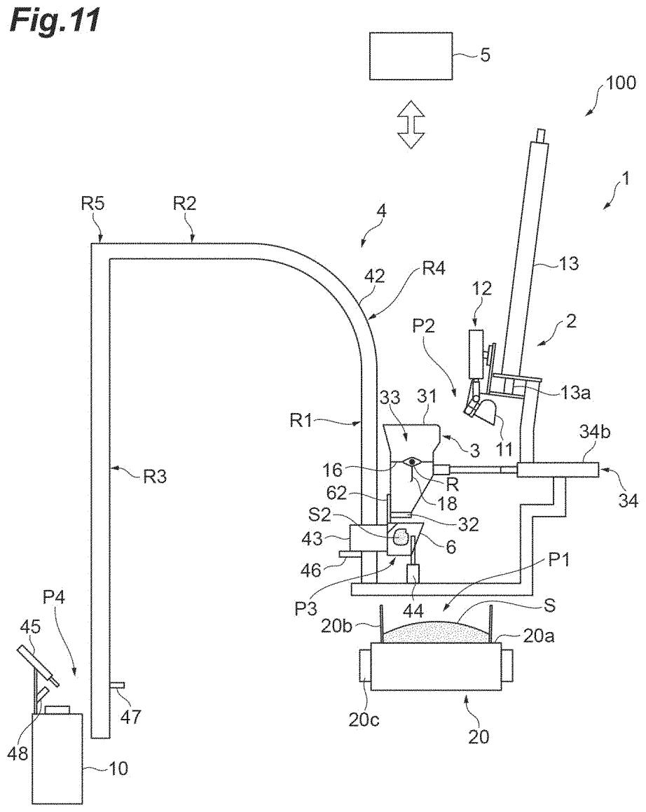

Next, as shown in FIG. 10, the control unit 5 drives the conveyance container drive unit 43 to move the empty conveyance container 6 supplied with the molding sand S1 from the supply position P4 to the receiving position P3 along the guide member 42. Next, as shown in FIG. 11, the control unit 5 drives the lid opening and closing portion 44 to open the lid 62 of the conveyance container 6 arranged in the receiving position P3. Then, the control unit 5 drives the transfer container drive unit 34 to move the transfer container 3 to the position above the receiving position P3 again, and further rotates the separator 33 by 90° around the rotation shaft R to drop the molding sand S2 supported on the second plate 18. As a result, the molding sand S2 in the transfer container 3 is transferred to the conveyance container 6.

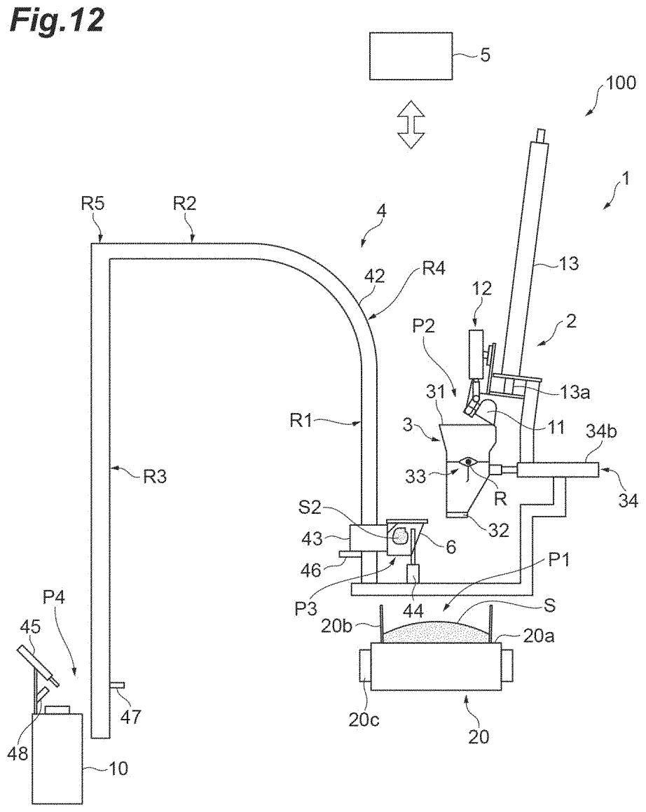

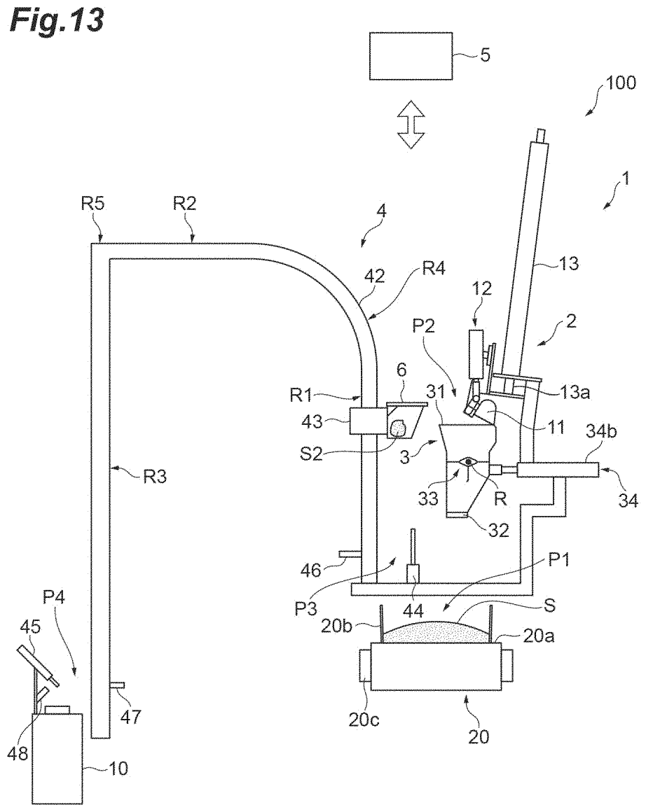

Next, as shown in FIG. 12, the control unit 5 drives the transfer container drive unit 34 to move the transfer container 3 to the position immediately below the passing position P2. Next, as shown in FIG. 13, the control unit 5 drives the conveyance container drive unit 43 to move the conveyance container 6 containing the molding sand S2 from the receiving position P3 to the supply position P4 along the guide member 42. Then, the molding sand 52 is supplied to the inspection device 10 at the supply position P4. The inspection device 10 inspects the properties of the molding sand S2 supplied from the conveyance container 6.

As described above, in the molding sand supply device 1 according to the above-described embodiment, since the molding sand S contained in the conveyance container 6 is transported along the bent guide member 42, it is possible to convey the molding sand S to the supply position P4 distant from the sampling position P1 while avoiding interference with existing equipment. As a result, the inspection device 10 to which the molding sand is to be supplied can be disposed at a position away from the sampling position P1, and an enhanced flexibility of the layout of the facility can be provided.

In addition, in the molding sand supply device 1, the molding sand S is divided into two by the separator 33, and the molding sand S 1 and the molding sand S2 are sequentially supplied to the inspection device 10. Since the molding sand S1 and the molding sand S2 are sampled from the conveyor 20 at the same timing, even in a case where the molding sand S1 and the molding sand S2 are inspected in two separate operations, it is possible to suppress the variation in the measurement result caused by the difference in the sampling timing.

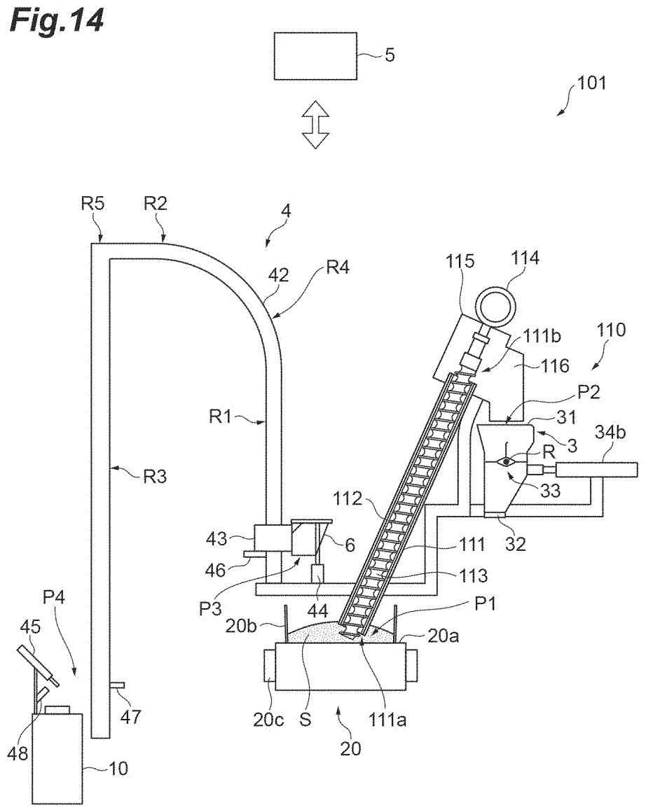

Hereinafter, modified examples of the molding sand supply device will be described. FIG. 14 is a schematic diagram illustrating a molding sand inspection system including a molding sand supply device 101. The molding sand supply device 101 is different from the molding sand supply device 1 illustrated in FIG. 1 in that a screw type sampling device 110 is provided instead of the bucket type sampling device 2, Hereinafter, differences from the molding sand supply device 1 will be mainly described, and their redundant description are omitted.

The sampling device 110 shown in FIG. 14 includes an outer cylindrical body 111, an inner cylindrical body 112, a screw 113, and a screw drive unit 114. The outer cylindrical body 111 has a cylindrical shape, and has a sand supply port 111a formed at one end thereof and a sand discharge port 111b formed at the other end thereof. The sand supply port 111a is located on the belt 20a of the conveyor 20. That is, the sand supply port 111a is disposed at the sampling position P1 where the molding sand S is sampled. On the other hand, the sand discharge port 111b is disposed at a position separated from the conveyor 20. The inner cylindrical body 112 has a cylindrical shape and is detachably fixed to the inner surface of the outer cylindrical body 111. An elongated screw 113 is disposed inside the inner cylindrical body 112 so as to be rotatable about the central axis. A spiral blade is formed on the outer peripheral surface of the screw 113. The screw 113 functions as a sampling tool for sampling the molding sand S.

One end of the screw 113 is disposed at a position close to the sand supply port 111a. The other end of the screw 113 is disposed at a position close to the sand discharge port 111b, and is connected to the screw drive unit 114. The screw drive unit 114 is, for example, a motor and rotationally drives the screw 113 around the central axis. The operation of the screw drive unit 114 is controlled by the control unit 5. In one embodiment, a casing 115 is provided around the other end of the screw 113 to cover the other end. The screw drive unit 114 is, for example, fastened to the casing 115, Below the casing 115, a chute 116 communicating with the sand discharge port 111b is provided. The chute 116 guides the molding sand S discharged from the sand discharge port 111b downward.

In the molding sand supply device 101, when the screw 113 is rotated by the operation of the screw drive unit 114, the molding sand S flowing through the conveyor 20 is collected and conveyed from the sand supply port 111a to the sand discharge port 111b by the blade of the screw 113, Molding sand S reaching the sand discharge port lift falls into the chute 116 and is discharged. The discharge position where the molding sand S is discharged from the chute 116 is a passing position P2 where the molding sand. S is passed to the transfer container 3. Therefore, as shown in FIG. 14, the molding sand S discharged from the chute 116 is supplied to the transfer container 3 disposed immediately below the passing position P2, As described above, the molding sand S supplied to the transfer container 3 is transferred to the conveyance container 6 and is conveyed to the supply position P4 along the curved conveyance path by the conveying device 4.

Similarly to the molding sand supply device 1, according to the molding sand supply device 101, since the molding sand S can be conveyed to the supply position P4 distant from the sampling position P1 while avoiding interference with the existing equipment, it is possible to enhance the flexibility in the layout of the facility.

In one embodiment, the molding sand supply device may have a sampling device other than a bucket or screw type sampling device to collect the molding sand. For example, the molding sand S collected by the sampling tool may be supplied to the transfer container 3 by moving the sampling tool between the sampling position P1 and the passing position P2 in a state where the sampling tool for sampling the molding sand S is suspended by a crane.

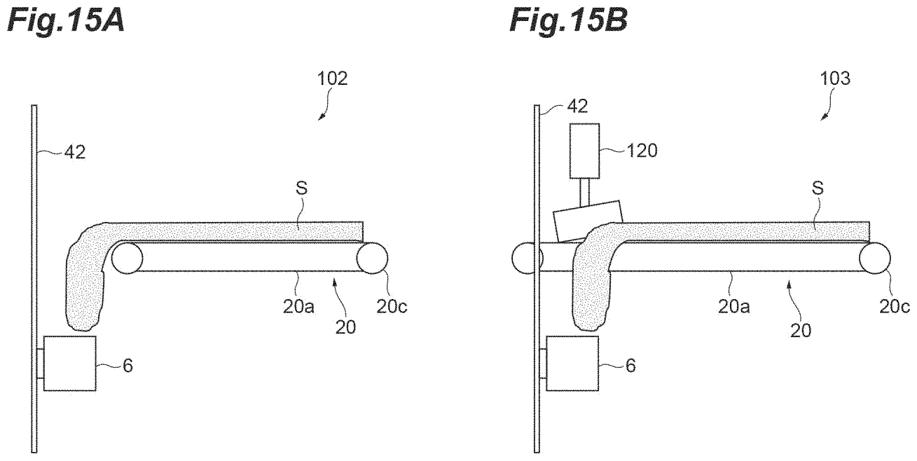

In one embodiment, the molding sand supply device may not include a sampling device. FIG. 15A shows another modified example of the molding sand supply device. The molding sand supply device 102 does not include the sampling device 2, and instead, the conveyance container 6 is disposed near the end of the conveyor 20 so as to receive the molding sand S falling from the conveyor 20. In the molding sand supply device 102, the molding sand S received by the conveyance container 6 from the conveyor 20 can be conveyed to the supply position P4 along the guide member 42.

FIG. 15B shows another modified example of the molding sand supply device. The molding sand supply device 103 illustrated in FIG. 15B does not include the sampling device 2, and instead, the conveyance container 6 is arranged below the conveyor 20 so that the conveying container 6 receives the molding sand S dropped from the conveyor 20 by a scraper 120. In the molding sand supply device 103 the molding sand S received by the conveyance container 6 from the conveyor 20 can be conveyed to the supply position P4 along t guide member 42.

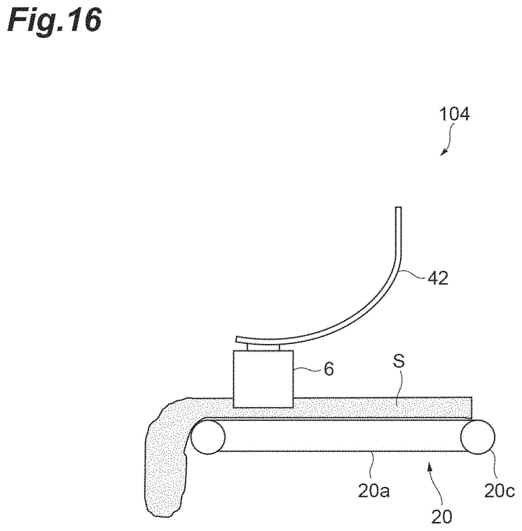

FIG. 16 shows another modified example of the molding sand supply device. In the molding sand supply device 104 illustrated in FIG. 16, the guide member 42 extends above the conveyor 20, and by moving the conveyance container 6 along the guide member 42, the molding sand S on the conveyor 20 can be scooped by the conveyance container 6. In the molding sand supply device 104, the molding sand S scooped by the conveyance container 6 can be conveyed to the supply position P4 along the guide member 42.

As described above, the molding sand supply devices 102, 103 and 104 are configured to collect the molding sand S by the conveyance container 6 without the sampling devices 2 and 110, In these modified examples, the conveyance container 6 functions as a sampling tool to sample the molding sand S.

Although the molding sand supply device and the molding sand inspection system according to various embodiments have been described above, the present invention is not limited to the above-described embodiments, and various modifications may be made without departing from the scope of the invention.

For example, in the embodiment shown in FIG. 2, the conveying device 4 moves the carrier 43b supporting the conveyance container 6 together with the magnet 43a by the compressed air, but the conveying device 4 is not limited to the above-described configuration as long as the molding sand S can be conveyed to the supply position P4 along the bent conveyance path. For example, the conveying device 4 may include a hollow pipe-shaped guide member 42, the conveyance container 6 may be disposed inside the guide member 42, and the conveyance container 6 may be conveyed to the supply position P4 along the guide member 42 using compressed air or vacuum pressure.

The power for conveying the conveyance container 6 is not limited to compressed air. For example, the conveyance container 6 may be conveyed by winding up a wire or chain connected to the conveyance container 6 by a winch and the like, or the conveyance container 6 may be conveyed to the supply position P4 by the driving force of a motor mounted on the carrier 43b. Further, the conveying device 4 may not necessarily include the guide member 42, and the conveyance container 6 accommodating the molding sand may be conveyed in the air to the supply position P4 by a drone and the like.

Further, in the embodiment illustrated in FIG. 1, the separator 33 is disposed inside the transfer container 3, but the separator 33 may be disposed at a position other than the transfer container 3. For example, the separator 33 may be disposed inside the conveyance container 6 to divide the molding sand S sampled by the sampling device 2 into two inside the conveyance container 6. In this case, when the conveyance container 6 is transferred and located at the supply position P4, the control unit 5 rotates the rotation shaft R of the separator 33 by 90°, drops the molding sand S1 placed on the first region 16a and supplies the molding sand S1 to the inspection device 10. After the inspection of the molding sand S1 is completed, the control unit 5 further rotates the rotation shaft R of the separator 33 by 90° to supply the molding sand S2 to the inspection device 10. Thus, the inspection device 10 can inspect the properties of the molding sand in two separate operations.

In another embodiment, the separator 33 may be provided at the inlet of the inspection device 10. For example, a chute for guiding the molding sand S supplied from the conveyance container 6 into the inspection device 10 may be provided at the inlet of the inspection device 10, and the separator 33 may be disposed in the chute. The separator 33 divides the molding sand supplied from the conveyance container 6 into two, and supplies the divided molding sand S to the inside of the inspection device 10 in two operations.

The molding sand supply device does not necessarily include the separator 33, and the sampled molding sand S may be supplied to the inspection device 10 at one time. In the molding sand supply device 1, the molding sand S sampled by the sampling device 2 is transferred to the conveyance container 6 via the transfer container 3, but the molding sand S sampled by the sampling device 2 may be directly transferred to the conveyance container 6 without using the transfer container 3.

In the above-described embodiment, the molding sand supply device 1 supplies the molding sand S to the inspection device 10 to inspect the molding sand. However, the molding sand supply device 1 can supply the molding sand S to any external device other than the inspection device. Examples of the external device to which the molding sand S is supplied include a molding machine and a sand muller. The various embodiments described above can be combined to the extent that there is no contradiction.

What is claimed is:

1. A molding sand supply device comprising:
a sampling tool to sample molding sand; and
a conveying device to convey the molding sand sampled by the sampling tool to a supply position along a bent conveyance path.

2. The molding sand supply device according to claim 1, wherein the conveyance path is a three-dimensionally bent path.

3. The molding sand supply device according to claim 1, wherein the sampling tool includes a bucket, and
wherein the molding sand supply device further comprises:
a bucket drive unit to rotatably support and drive the bucket; and
a moving unit to linearly move the bucket drive unit.

4. The molding sand supply device according to claim 1, further comprising a conveyance container to receive the molding sand sampled by the sampling tool,
wherein the conveying device conveys the conveyance container containing the molding sand to the supply position along the conveyance path.

5. The molding sand supply device according to claim 4, wherein the conveying device includes:
a guide member extending along the conveyance path; and
a conveyance container drive unit to move the conveyance container from a receiving position to the supply position along the guide member, wherein the receiving position is where the conveyance container receives the molding sand.

6. The molding sand supply device according to claim 5, wherein the conveyance container drive unit includes:
a magnet disposed inside the guide member;
a carrier to move along the guide member together with the magnet due to an attractive force of the magnet, the conveyance container being fixed to the carrier; and
a compressed air supply unit to supply compressed air into the guide member to move the magnet along the guide member.

7. The molding sand supply device according to claim 4, wherein the conveyance container includes:
a container body to contain the molding sand;
a lid openably and closably provided on an upper portion of the container body; and
an elastic body to bias the lid into a closed position with respect to the container body.

8. The molding sand supply device according to claim 4, wherein the conveyance container includes:
a container body to contain the molding sand;
a lid openably and closably provided on an upper portion of the container body; and
a locking mechanism to lock the lid to the container body.

9. The molding sand supply device according to claim 4, further comprising a blower to blow gas into the conveyance container.

10. The molding sand supply device according to claim 4, further comprising a separator to divide the molding sand sampled by the sampling tool into two.

11. A molding sand inspection system comprising:
a sampling tool to sample molding sand;
a conveying device to convey the molding sand sampled by the sampling tool to a supply position along a bent conveyance path; and
an inspection device to receive the molding sand conveyed to the supply position to inspect properties of the molding sand.
